(19) United States
(12) Patent Application Publication
(10) Pub. No.: US 2002/0064763 A1
(43) Pub. Date: May 30, 2002

(54) Constellatory observation assisting apparatus

(76) Inventor: Akihiro Aoyama, Shizuoka-ken (JP)

Correspondence Address: BLANK ROME COMISKY & MCCAULEY, LLP, 900 17TH STREET, N.W., SUITE 1000, WASHINGTON, DC, 20006, US

(21) Appl. No.: 09/989,193

(22) Filed: Nov. 21, 2001

(30) Foreign Application Priority Data
Nov. 24, 2000 (JP) 2000-356977

(51) Int. Cl. G04B 19/22

(52) U.S. Cl. 434/142

(57) ABSTRACT

Disclosed herein is a constellatory observation assisting apparatus. The apparatus is equipped with a time information acquisition section for acquiring data information on a specific time, a positional information acquisition section for acquiring positional information on a position on the earth, and a heading acquisition section for acquiring heading information on an constellatory observation heading. The apparatus is also equipped with a storage section for storing star chart data, and a control section for reading out constellation image data, which is seen at the specific time and position and in the heading, from the star chart data, based on the time information, the positional information, and the heading information. The apparatus is further equipped with a display unit for displaying the constellation image data read out by the control section.

### BACKGROUND OF THE INVENTION

1. Field of the Invention

The present invention relates to a constellatory observation assisting apparatus, and more particularly to a constellatory observation assisting apparatus that is capable of providing accurate star map information, taking the position of an observer into consideration, with simple operation.

2. Description of the Related Art

In observing the sky and finding out a desired constellation, it is fairly difficult to memorize the shapes, names, positions, etc., of all constellations. For this reason, some observation assisting tool is necessary. For instance, there are cases where an assisting tool called a star plate is employed. The star plate has two stacked disks. The radially outer edge of one of the two disks is provided with a date scale, while the radially outer edge of the other is provided with a hour scale. When using the star plate, the two stacked disks are relatively rotated so that the present date and hour are obtained. If the present time is 9 in the afternoon of January 1, the outer disk is rotated with the inner disk held with the hand, and the “January 1” on the date scale of the outer disk is aligned with the “9 p.m. (or 21:00)” on the hour scale of the inner disk.

The disk surface of the outer disk has a sky chart in which all constellation lines and constellation names are shown. A portion of the sky chart can be seen through an elliptical bore formed in the disk surface of the inner disk. Therefore, if the present time is set in the above-mentioned manner, the state of the sky at the present time can be known through the elliptical bore of the inner disk. By comparing the obtained sky with the actual sky, a desired constellation can be discovered and the name of a constellation can be found out.

However, such an observation assisting tool (star plate) requires the operation of rotating two disks, and in addition, input information is limited to the present time. Since accurate positional information on an observer (coordinate information on a position on the earth) is not taken into consideration, the position of a constellation obtained by the conventional observation assisting tool is not aligned with that of the actual constellation. Thus, there is a problem that the conventional observation assisting tool will lack accuracy.

### SUMMARY OF THE INVENTION

The present invention has been made in view of the circumstances mentioned above. Accordingly, it is the primary object of the present invention to realize a constellatory observation assisting apparatus that is capable of providing accurate star map information containing the positional information on an observer as well as the present date and hour.

To achieve this end, there is provided a constellatory observation assisting apparatus comprising: time information acquisition means for acquiring time information on a specific time; positional information acquisition means for acquiring positional information on a position on the earth; heading acquisition means for acquiring heading information on an constellatory observation heading; storage means for storing star chart data; control means for reading out constellation image data, which is seen at the specific time and position and in the heading, from the star chart data, based on the time information, the positional information, and the heading information; and display means for displaying the constellation image data read out by the control means.

According to the present invention, star map information, containing an observation position and an observation heading as well as the present date and hour, is presented to an observer. Therefore, the present invention is capable of providing accurate star map information containing positional information on an observer as well as the present date and hour.

In a preferred form of the present invention, the control means reads out the constellation image data from the star chart data when the positional information or heading information changes beyond a predetermined quantity.

Thus, when the positional information or heading information changes beyond a predetermined quantity, the display of the star map information is updated. Therefore, even if the processing ability of an apparatus is low, it can be used without feeling stress.

In another preferred form of the present invention, the positional information acquisition means acquires the positional information by utilizing a global positioning system, and the heading information acquisition means acquires the heading information by utilizing a change in time between two pieces of positional information acquired by the positional information acquisition means.

Thus, positional information is acquired by utilizing the global positioning system, and heading information is also acquired by the positional information. Therefore, there is no need to use a magnetic amplitude sensor such as a magnetic sensor, etc., and a reduction in the apparatus cost can be achieved.

### BRIEF DESCRIPTION OF THE DRAWINGS

The above and other objects and advantages will become apparent from the following detailed description when read in conjunction with the accompanying drawings wherein:

FIG. 1 is a schematic diagram showing a constellatory observation assisting apparatus constructed according to a preferred embodiment of the present invention;

FIG. 2 is a conceptual block diagram showing the electrical construction of the constellatory observation assisting apparatus of the preferred embodiment;

FIG. 3 is a conceptual construction diagram of the application section of the constellatory observation assisting apparatus of the preferred embodiment;

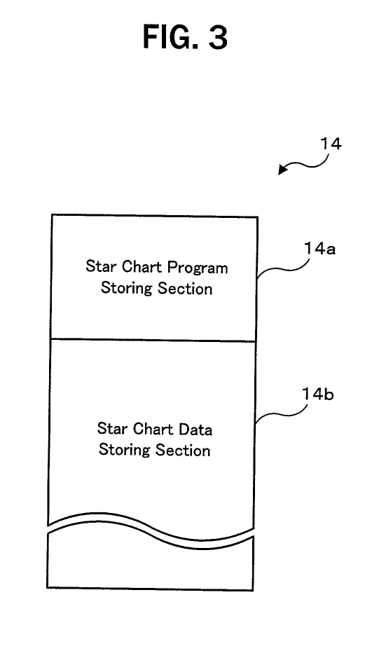

FIG. 4 is a conceptual diagram showing how start chart information is provided by the constellatory observation assisting apparatus of the preferred embodiment; and

FIG. 5 is a diagram showing an example displayed on the liquid crystal display of the constellatory observation assisting apparatus of the preferred embodiment.

### DETAILED DESCRIPTION OF THE PREFERRED EMBODIMENTS

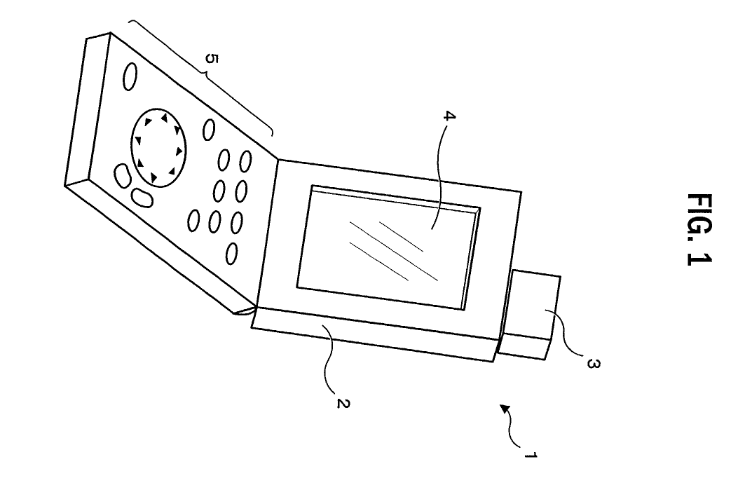

Referring now in greater detail to the drawings and initially to FIG. 1, there is shown a constellatory observation assisting apparatus 1 (hereinafter referred to simply as an observation apparatus) in accordance with the present invention. The observation apparatus 1 is equipped with a portable case 2 (although the illustrated example is of a folding type, the present invention is not limited to this), a GPS antenna 3, a liquid crystal display 4, and a key control section 5.

The GPS antenna 3 is an antenna element for receiving electronic radio waves for a global positioning system (GPS). The electronic radio waves are position measuring radio waves (among which, a commercial radio wave is a radio wave L1 of wavelength 19 cm) that are emitted from a plurality of satellites circling along 6 orbits of altitude about 20200 km above the earth and inclination angle 55° in about 12 hours. In the GPS, the position (latitude and longitude) of any region on the earth can be specified by receiving electronic radio waves from 3 or more satellites.

The liquid crystal display 4 is used to display a desired star chart and has resolution to the degree that spot information and character information such as time information can be displayed. It is preferable that the liquid crystal display 4 be a color liquid crystal display panel and further preferable that it be a liquid crystal display panel with a touch panel.

The key control section 5 is equipped with a power switch for the observation apparatus 1, and various function keys, a menu key, a scroll key, and a zoom key which are employed for constellatory observation and other functions. In the case where the observation apparatus 1 is utilized not only for constellatory observation but also for other applications, for example, a GPS terminal and a map terminal, the operability can be improved, if a specific key is employed only for a starting key for a “constellatory observation function” and is constructed so that other functions can be switched to the constellatory observation function when the specific key is depressed.

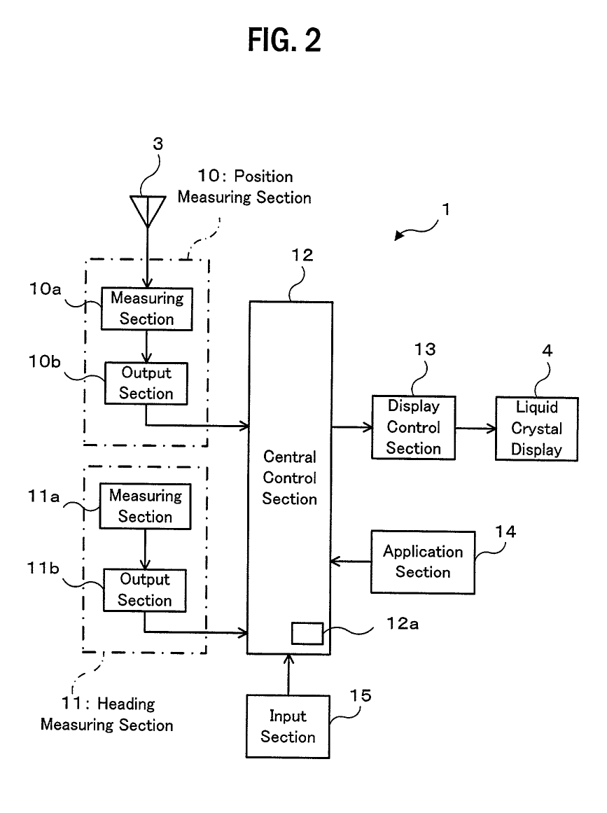

FIG. 2 shows the electrical construction of the observation apparatus 1. As shown in the figure, the observation apparatus 1 is constructed of a position measuring section 10, a heading measuring section 11, a central control section 12, a display control section 13, an application section 14, and an input section 15. The functions of the sections are as follows.

The position measuring section 10 consists of a measuring section 10a and an output section 10b. The measuring section 10a specifies the position (latitude and longitude) of the observation apparatus 1 on the earth by analyzing the electronic radio waves from the GPS satellites, received with the GPS antenna 3. The output section 10b converts the specified positional information to a predetermined format and outputs it to the central control section 12.

The position measuring principle of the GPS is as follows: For example, assume that the positions of 3 satellites A, B, and C are known. If a distance from the satellite A to the position of the observation apparatus 1 is assumed to be a, the observation apparatus 1 is situated at a certain point on the surface of the sphere A′ of radius a with the satellite A as center. At the same time, if a distance from the satellite B to the position of the observation apparatus 1 is assumed to be b, the observation apparatus 1 is situated at a certain point on the circumference where the sphere a′ with a radius of a and the sphere B′ with a radius of b overlap each other. Furthermore, if a distance from the satellite C to the position of the observation apparatus 1 is assumed to be c, the position of the observation apparatus 1 is situated at the intersection between the spheres A′, B′, and C′. In an actual measurement, a signal is received from the fourth satellite and used for a correction of time shift. Note that although the position of a satellite is expressed by a fixed orthogonal coordinate system, it can be calculated by employing the 6 calculation parameters of orbital information transmitted from satellites (6 orbital elements: long radius, eccentricity, orbital inclination, north-bound node longitude, and perigee argument).

The heading measuring section 11, as with the position measuring section 10, consists of a measuring section 11a and an output section 11b. The measuring section 11a of the heading measuring section 11 measures the heading of the observation apparatus 1, based on a signal from a heading sensor such as a geomagnetic sensor, etc. The output section 10b converts the measured heading information to a predetermined format and outputs it to the central control section 12.

In the case where the observation apparatus 1 is of a folding type such as that shown in FIG. 1, the heading of the observation apparatus 1 is expressed by the direction of a normal Line relative to the back surface of the liquid crystal display 4 in the erected state. For example, when the heading of the observation apparatus 1 is north, the backside of the liquid crystal display 4 is headed to the north (the display screen side of the liquid crystal display 4 is headed to the south). Therefore, the operator of the observation apparatus 1 can turn to the same direction (north), and the observation heading of the observer (heading where the observer tries to look at a constellation) can be aligned with the heading of the observation apparatus 1.

It is preferable from the viewpoint of accuracy of measurement and responsivity of measurement that the measuring section 11a of the heading measuring section 11 employ a heading sensor such as a geomagnetic sensor, etc. However, the present invention is not limited to the heading sensor. For instance, it is also possible to utilize the result of a position obtained by the GPS. That is, when the observer (observation apparatus 1) moves from point a to point b, the direction of a line passing through the point a and the point b is the moving direction of the observer (observation apparatus 1), and the moving direction can be employed instead of the heading information obtained by 14 the aforementioned heading sensor.

The central control section 12 is a section that controls the entire operation of the observation apparatus 1. The central control section 12 includes hardware resources such as a central processing unit (CPU), a program memory, a work memory, etc., and also includes various software resources which realize necessary control functions by organically coupling with these hardware resources. The software resources include an operating system stored in the program memory (not shown), and a user application program, which is to be described later, designed to make the observation application 1 have an assisting function for constellatory observation.

The display control section 13 drives the liquid crystal display 4 according to a display signal output from the central control section 12 so that a desired star chart, spot information, and character information such as time information are displayed on the screen.

The application section 14 stores the above-mentioned user application program, designed so that it is organically coupled with the hardware resources or operating system of the central control section 12 to make the observation application 1 have an assisting function for constellatory observation. This application section 14 is constructed of a fixed or detachable storage medium, and the interior is equipped with a star chart program storing section 14a and a star chart data storing section 14b. The star chart program storing section 14a stores the main body of the above-mentioned user application program (hereinafter referred to as a star chart program). The star chart data storing section 14b stores star chart data required for execution of the star chart program. The star chart data is the data of a sky chart showing all constellation lines and constellation names. Particularly, if position coordinates, a heading, and the present time (date and hour) are specified, the image data of the sky that is seen at the specified position and time and in the specified heading can be partially read out and output.

The input section 15 generates a control signal for each of the key switches provided in the aforementioned key control section 5 and outputs it to the central control section 12.

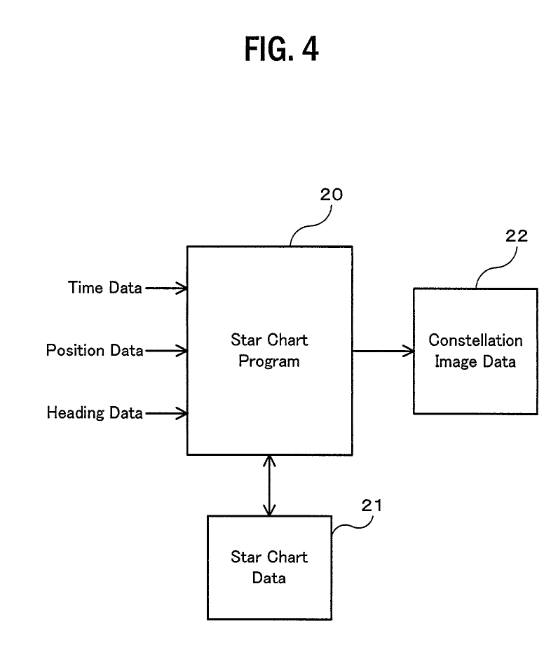

FIG. 4 shows how star chart information is provided by the observation apparatus 1. If the star chart program 20 receives the present time data, position data for an observer, and observation heading data, the star chart program 20 refers to the star chart data 21 stored in the star chart data storing section 14b, based on the input data. The star chart program 20 reads out a range, which is seen at the input time and position and in the input heading, from the star chart data 21, and outputs the read image data to the display control section 13 as extracted constellation image data 22.

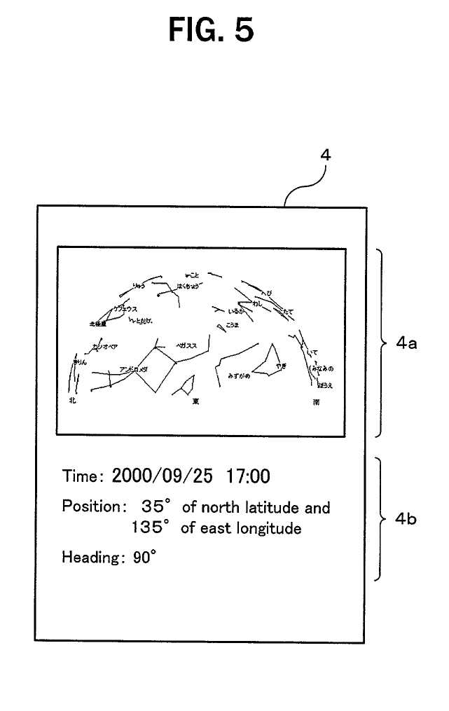

FIG. 5 shows an example displayed on the liquid crystal display 4. The liquid crystal display 4 has an image data display area 4a on which the extracted constellation image data 22 is displayed, and an extracting-condition display section 4b on which the extracting conditions (time, position, and heading) for the extracted constellation image data 22 are displayed. Among the extracting conditions, the “time” is obtained by the time measuring section 12a of the central control section 12, and the “position” and the “heading” are obtained by the measuring functions of the position measuring section 10 and the heading measuring section 11. Therefore, the observation apparatus 1 of the preferred embodiment is capable of reading out the image data of the sky aligned with the present position and observation heading of the observer and then displaying the read image data on the liquid crystal display 14.

Therefore, according to the preferred embodiment, there is an advantage that accurate star chart information, containing the position and observation heading of an observer as well as a specific time, can be provided. The preferred embodiment is also capable of displaying the desired image data of the sky on the liquid crystal display 4 only by turning on the star chart function of the observation apparatus 1 and then turning the front end of the observation apparatus 1 to the direction of a desired constellation. Therefore, the preferred embodiment does not require a special operation such as that in the conventional star plate, and there is another advantage that the observation apparatus 1 can be easily operated.

Ideally, it is desirable that when the position or heading of the observation apparatus 1 is changed, displayed image data be updated in real time. However, since the observation apparatus 1 has a limit to the processing ability, the displayed image data may be updated when the position or heading of the observation apparatus 1 changes beyond a predetermined quantity. In addition, the observation apparatus 1 may be constructed so that if a constellation within the screen is specified with a cursor, a detailed description on the constellation is displayed, or games related to the constellation are displayed.

While the present invention has been described with reference to the preferred embodiment thereof, the invention is not to be limited to the details given herein, but may be modified within the scope of the invention hereinafter claimed. 12

What is claimed is:

1. A constellatory observation assisting apparatus comprising:
time information acquisition means for acquiring time information on a specific time;
positional information acquisition means for acquiring positional information on a position on the earth;
heading acquisition means for acquiring heading information on an constellatory observation heading;
storage means for storing star chart data;
control means for reading out constellation image data, which is seen at said specific time and position and in said heading, from said star chart data, based on said time information, said positional information, and said heading information; and
display means for displaying said constellation image data read out by said control means.

2. The constellatory observation assisting apparatus as set forth in claim 1, wherein said control means reads out said constellation image data from said star chart data when said positional information or heading information changes beyond a predetermined quantity.

3. The constellatory observation assisting apparatus as set forth in claim 1, wherein said positional information acquisition means acquires said positional information by utilizing a global positioning system, and said heading information acquisition means acquires said heading information by utilizing a change in time between two pieces of positional information acquired by said positional information acquisition means.

4. The constellatory observation assisting apparatus as set forth in claim 2, wherein said positional information acquisition means acquires said positional information by utilizing a global positioning system, and said heading information acquisition means acquires said heading information by utilizing a change in time between two pieces of positional information acquired by said positional information acquisition means.
